(19) United States
(12) Patent Application Publication
(10) Pub. No.: US 2019/0390458 A1
(43) Pub. Date: Dec. 26, 2019

(54) SOUND-ABSORBING DEVICE

(71) Applicant: LTS Licht & Leuchten GmbH, Tettnang (DE)

(72) Inventor: Ewald Steinel, Berg (DE)

(21) Appl. No.: 16/415,013

(22) Filed: May 17, 2019

(30) Foreign Application Priority Data
Jun. 25, 2018 (EP) 18 179 469.4

(51) Int. Cl. E04B 1/84; F21V 33/00

(52) U.S. Cl. CPC E04B 1/84; E04B 2001/8263; F21V 33/0056

(57) ABSTRACT

In a sound-absorbing device (1) which is suspended from ceilings (3) in rooms (2), comprising
a frame (4) which is fastened at a distance from the ceiling (3) and parallel thereto, and
at least one flat structure with sound-absorbing properties which is inlaid or inserted into the frame (4),
   on the one hand a sound-absorbing property should be present as far as possible over the entire surface of the ceiling (3) and on the other hand sufficient illumination should be possible for the interior of the room. This is solved in accordance with the present invention by at least one intermediate space (11) being provided in the flat structure (5), by one or more lighting means (12) being arranged in the respective intermediate space (11), and by each of the lighting means (12) being locked to the frame (4) directly or by means of support elements (13).

### REFERENCE TO PENDING PRIOR PATENT APPLICATION

This patent application claims benefit of European Patent Application No. 18 179 469.4, filed Jun. 25, 2018, which patent application is hereby incorporated herein by reference.

### FIELD OF THE INVENTION

The present invention refers to a sound-absorbing device which is mounted at a distance from ceilings of rooms and parallel to them.

### BACKGROUND OF THE INVENTION

In conference rooms in particular, it has been found that the background noise caused by sound waves can disrupt the conversation and must therefore be attenuated. For this reason, rooms with correspondingly large dimensions are often clad with flat structures that have a sound-absorbing property in order to attenuate or absorb the sound waves generated during conversations. These flat structures are inlaid or inserted into a frame and the frame is attached to the ceiling by means of wires or pipe sections, for example.

The flat structures equipped with sound-absorbing properties have proved their worth in practice for absorbing sound waves, but such rooms often require sufficient lighting, as documents must be viewed inside them. The flat structures used have a rectangular outer contour, so that the frames consist of a composite of frames which can be taken out individually in order to insert a ceiling lamp into the free space created in this way, by means of which the required lighting is provided. However, these free spaces created in this way do not have any sound-absorbing properties; rather, the sound waves reach the ceiling unhindered and are reflected back into the interior of the room by it. The more free spaces are needed to create the necessary lighting, the more disturbing are the ambient noises caused by the sound, since the sound waves enter the interior of the room in a correspondingly large number.

### SUMMARY OF THE INVENTION

It is therefore the task of the present invention to further develop a sound-absorbing device of the aforementioned type in such a way that, on the one hand, the sound-absorbing property is present over the entire surface of the ceiling as far as possible and, on the other hand, sufficient lighting is possible for the interior of the room.

This task is solved in accordance with the present invention by the features of the characterising part of Patent claim 1.

Further advantageous embodiments of the present invention are derived from the subordinate claims.

By providing at least one intermediate space in the flat structure, by arranging one or more lighting means in the respective intermediate space and by locking each of the lighting means directly or by means of support elements on the frame, it should be ensured that the sound waves produced by conversations and other noises are sufficiently absorbed and that at the same time the interior of the room is provided with sufficient lighting.

Since a cover plate is provided on the frame which provides a support against the direction of gravity, both the flat structures and the lighting means can be inlaid or inserted into the respective frame, so that no additional fastening elements are required, making the assembly of the sound-absorbing device quick and inexpensive. The cover plate therefore holds the flat structures and the lighting means in place.

In order to optimise both the illumination and the sound-absorbing properties of the flat structures, the cover plate incorporates a large number of through-openings and lighting penetrations, which are either assigned to the respective flat structure or to the respective LED of the lighting means. Thus, the sound waves can penetrate almost unhindered through the through-openings into the flat structure, which is preferably configured as a polyester fleece, and are absorbed there; the light waves generated by the respective LEDs enter the room through the lighting penetrations into the interior, so that it is illuminated accordingly.

The flat structures thus prevent the sound waves from the ceiling from being reflected back into the room or from being reflected by it, which means that disturbing noise levels are attenuated. With the aid of the lighting means, which are preferably arranged in two parallel rows, a very small amount of space is required in relation to the surface areas of the ceilings covered by the flat structures, so that the sound-absorbing properties of the device predominate.

### BRIEF DESCRIPTION OF THE DRAWINGS

The drawing shows a sample embodiment configured in accordance with the present invention, the details of which are explained below. In the drawing:

FIG. 1 shows a plurality of devices suspended from a ceiling of a room, consisting of three flat structures and two intermediate spaces incorporated into them, in which lighting means in the form of LEDs are arranged in pairs in a row, in perspective view,

FIG. 2 shows one of the devices in accordance with FIG. 1 in exploded view,

FIG. 3 shows a top view of one of the devices in accordance with FIG. 1, and

FIG. 4a and FIG. 4b show a section along the line IVa-IVa in FIG. 3 and a section along the line IVb-IVb in FIG. 3.

### DETAILED DESCRIPTION OF THE PREFERRED EMBODIMENTS

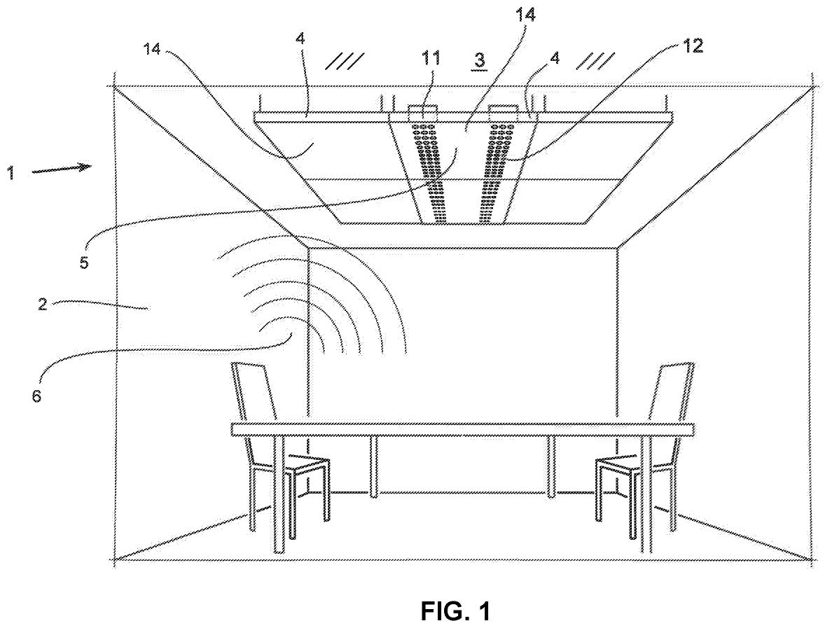

FIG. 1 shows a schematic view of a usual meeting situation in a room 2, in which two devices 1 in accordance with the present invention are suspended from the ceiling 3 of the room 2 by means of which, for example, sound waves 6 generated by conversations are absorbed, so that they are not reflected back into the interior of the room by the ceiling 3 and, at the same time, sufficient illumination of the room 2 should be set.

The device 1 consists of three flat structures 5 which are inserted into a frame 4 which is placed at a distance from the ceiling 3 and parallel to it. The frame 4 can have an L-shaped cross-sectional structure, so that the respective flat structures 5 are supported by the surrounding frame 4. The frames 4 suspended from the ceiling 3 adjacent to the device 1 in the invention have the same outer dimensions, but consist exclusively of a relevant flat structure 5, so that they are used exclusively for sound absorption.

The device 1 in accordance with the present invention, on the other hand, has an intermediate space 11 between two adjacent flat structures 5 in which lighting means 12 are inserted. The lighting means 12 consist of a large number of LEDs arranged in pairs in a row. Consequently, the rows of lighting means 12 occupy a much smaller area than the adjacent flat structures 5, so that the predominant surface area of the device 1 has sound absorbing properties and only a much smaller surface area provides the lighting for the room 2.

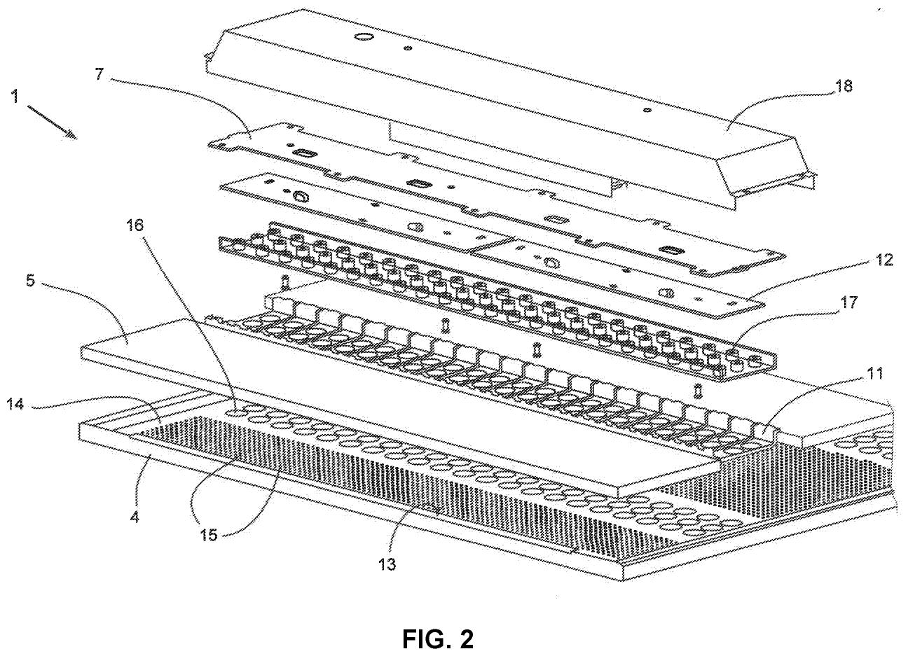

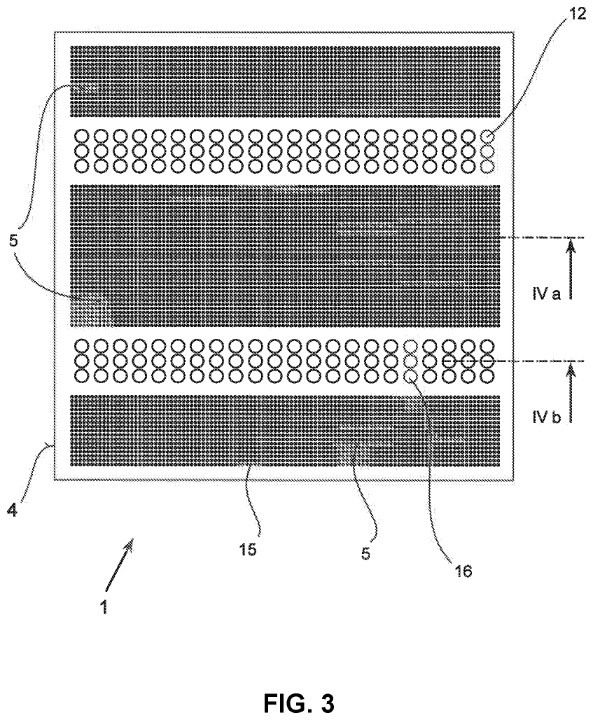

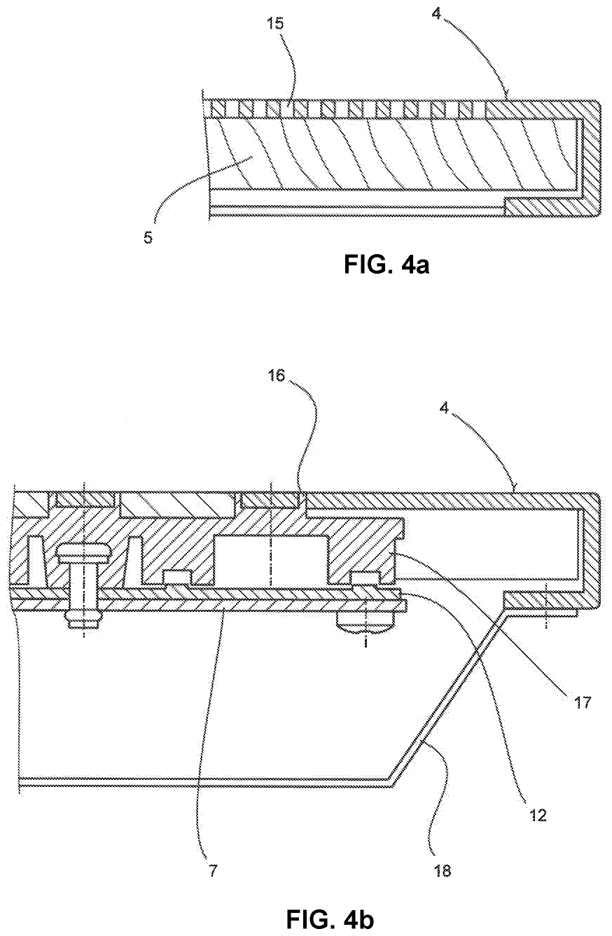

FIGS. 2, 3, 4a and 4b show that a cover plate 14 is inserted into or fixed to the frame 4. The cover plate 14 incorporates a large number of through-openings 15 as well as lighting penetrations 16. The through-openings 15 are arranged adjacent to the respective flat structures 5 and the lighting penetrations 16 are arranged in alignment with the respective lighting means 12. Consequently, the sound waves 6 can pass through the through-openings 15 in the direction of the respective flat structure 5 and the light waves emitted by the lighting means 12 are guided through the lighting penetrations 16 into the room 2.

At the same time, the cover plate 14 holds the flat structures 5 and the lighting means 12 against gravity on the frame 4. In order to avoid disturbing light reflections, a tube 17 is inserted between the cover plate 14 and the respective lighting means 12, so that the lighting means 12 are slightly distanced from the cover plate 14.

Electrical components 7 are required for the operation of the lighting means 12, for example in the form of printed circuit boards with electrical cables, transformers, resistors or the like. These electrical components 7 are arranged on the opposite side of the cover plate 14, i.e. above the lighting means 12, in the assembled state and are encapsulated by a cover 18. The cover 18 thus face towards the ceiling 3 and is arranged at a distance from it.

Adjacent frames 4 are located in one plane and there should be no or only a small air gap between them.

What is claimed is:

1. A sound-absorbing device (1) which is suspended from ceilings (3) in rooms (2), the sound-absorbing device comprising:
a frame (4) which is fastened at a distance from the ceiling (3) and running parallel thereto, and
at least one flat structure which is inserted or inserted into the frame (4) and has sound-absorbing properties,
characterised in that
at least one intermediate space (11) is provided in the at least one flat structure (5), in that one or more lighting means (12) are arranged in the respective intermediate space (11), and in that each of the lighting means (12) is locked to the frame (4) directly or by means of support elements (13).

2. The device in accordance with claim 1,
characterised in that
a cover plate (14) is provided on the frame (4), by means of which cover plate (14) the flat structures (5) and the lighting means (12) are held, and in that a plurality of through-openings (15) are worked into the cover plate (14), through which through-openings (15) the sound waves (6) are guided in the direction of the flat structure (5).

3. The device in accordance with claim 2,
characterised in that
the lighting means (12) are formed from a plurality of LEDs arranged in series with one another and in that each LED (12) is arranged at a distance from a lighting penetration (16) incorporated in the cover plate (14).

4. The device in accordance with claim 3,
characterised in that
a tube (17) is inserted between the individual LEDs (12) and the cover plate (14).

5. The device in accordance with claim 2,
characterised in that
cables and electrical components (7) required for the electrical operation of the lighting means (12) are arranged on the surface of the frame (4) opposite the cover plate (14) and in that these electrical components (7) are encapsulated by a cover (18).

6. The device in accordance with claim 1,
characterised in that
the flat structure (5) is composed of a polyester fleece.

7. The device in accordance with claim 1,
characterised in that
the flat structure (5) has a wall thickness of 10 mm.

8. The device in accordance with claim 1,
characterised in that
a plurality of frames (4) are arranged side by side in a common plane and that the surface of a ceiling (3) is completely covered by the number of inserted frames (4).
